(19) United States
(12) Patent Application Publication
(10) Pub. No.: US 2022/0214186 A1
(43) Pub. Date: Jul. 7, 2022

(54) AUTOMATED MAP MAKING AND POSITIONING

(71) Applicant: ZENUITY AB, Göteborg (SE)

(72) Inventors: Toktam BAGHERI, Hovås (SE); Mina ALIBEIGI, Göteborg (SE)

(21) Appl. No.: 17/609,033

(22) PCT Filed: May 6, 2019
(86) PCT No.: PCT/EP2019/061588

§ 371 Date: Nov. 5, 2021

(51) Int. Cl. G01C 21/00; G06K 9/62

(52) U.S. Cl. CPC G01C 21/3848; G01C 21/3819; G06K 9/629

(57) ABSTRACT

An automated map generation and map positioning solution for vehicles is disclosed. The solution includes a method for map generation based on the vehicle's sensory perception of the surrounding environment. Moreover, presented map generating method utilizes the inherent advantages of trained self-learning models (e.g. trained artificial networks) to efficiently collect and sort sensor data in order to generate high definition (HD) maps of a vehicle's surrounding environment “on-the-go”. In more detail, the automated map generation method utilizes two self-learning models are used, one general, low-level, feature extraction part and one high-level feature fusion part. The automated positioning method is based on similar principles as the automated map generation, where two self-learning models are used, one “general” feature extraction part and one “task specific” feature fusion part for positioning in the map.

### TECHNICAL FIELD

The present disclosure generally relates to the field of image processing, and in particular to a method and device for generating high resolution maps and positioning a vehicle in the maps based on sensor data by means of self-learning models.

### BACKGROUND

During these last few years, the development of autonomous vehicles has exploded and many different solutions are being explored. Today, development is ongoing in both autonomous driving (AD) and advanced driver-assistance systems (ADAS), i.e. semi-autonomous driving, within a number of different technical areas within these fields. One such area is how to position the vehicle consistently and precisely since this is an important safety aspect when the vehicle is moving within traffic.

Thus, maps have become an essential component of autonomous vehicles. The question is not anymore if they are useful or not, but rather how maps should be created and maintained in an efficient and scalable way. In the future of the automotive industry, and in particular for autonomous drive, it is envisioned that the maps will be the input used for positioning, planning and decision-making tasks rather than human interaction.

A conventional way to solve both the mapping and the positioning problems at the same time is using Simultaneous Localization and Mapping (SLAM) techniques. But SLAM methods do not perform very well in the real-world applications. The limitations and the noise in the sensor inputs propagate from the mapping phase to the positioning phase and vice versa, resulting in inaccurate mapping and positioning. Therefore, new accurate and sustainable solutions are needed that fulfil the requirements for precise positioning.

Other prior known solutions utilise 2D/3D occupancy grids to create maps as well as point cloud, objects-based and feature-based representations.

However, despite their good performance, the conventional solutions for creating maps have some major challenges and difficulties. For example, the process of creating maps is very time consuming and not fully automated, and the solutions are not fully scalable, so they do not work everywhere. Moreover, conventional methods usually consume a lot of memory to store high-resolution maps, and they have some difficulties in handling sensor noise and occlusion. Further, finding changes in the created maps and updating them is still an open question and it is not an easy problem for these methods to solve.

Thus, there is a need for new and improved methods and systems for generating and managing maps suitable for use as the main input for positioning, planning and decision-making tasks of autonomous and semi-autonomous vehicles.

### SUMMARY OF THE INVENTION

It is therefore an object to provide a method for automated map generation, a non-transitory computer-readable storage medium, a vehicle control device and a vehicle comprising such a control device, which alleviate all or at least some of the drawbacks of presently known solutions.

It is another object to provide a method for automated positioning of a vehicle on a map, a non-transitory computer-readable storage medium, a vehicle control device and a vehicle comprising such a control device, which alleviate all or at least some of the drawbacks of presently known solutions.

These objects are achieved by means of a method, a non-transitory computer-readable storage medium, a vehicle control device and a vehicle as defined in the appended claims. The term exemplary is in the present context to be understood as serving as an instance, example or illustration.

According to a first aspect of the present disclosure, there is provided a method for automated map generation. The method comprises receiving sensor data from a perception system of a vehicle. The perception system comprising at least one sensor type and the sensor data comprises information about a surrounding environment of the vehicle. The method further comprises receiving a geographical position of the vehicle from a localization system of the vehicle, and online extracting, using a first trained self-learning model, a first plurality of features of the surrounding environment based on the received sensor data. Furthermore, the method comprises online fusing, using a map generating self-learning model, the first plurality of features in order to form a second plurality of features, online generating, using the trained map generating self-learning model, a map of the surrounding environment in reference to a global coordinate system based on the second plurality of features and the received geographical position of the vehicle.

The method provides for a reliable and effective solution for generating maps online in a vehicle based on the vehicle's sensory perception of the surrounding environment. Thus alleviating the need for manually creating, storing and/or transmitting large amounts of map data. In more detail, the presented method utilizes the inherent advantages of trained self-learning models (e.g. trained artificial networks) to efficiently collect and sort sensor data in order to generate high definition (HD) maps of a vehicle's surrounding environment “on-the-go”. Various other AD or ADAS features can subsequently use the generated map.

Moreover, the general features (first plurality of features) may be understood as “low-level” features that describe information about the geometry of the road or the topology of the road network. These features could be like lane markings, road edges, lines, corners, vertical structures, etc. When they are combined, they can build more higher-level or specific features like lanes, drivable area, road work, etc.

A trained self-learning model may in the present context be understood as a trained artificial neural network, such as a trained convolutional or recurrent neural network.

Moreover, according to an exemplary embodiment of the present disclosure, the first trained self-learning model comprises an independent trained self-learning sub-model for each sensor type of the at least one sensor type. In addition, each independent trained self-learning sub-model is trained to extract a predefined set of features from the received sensor data of an associated sensor type. In other words, the first trained self-learning model has one self-learning sub-model trained to extract relevant features from data originating from a RADAR sensor, one self-learning sub-model trained to extract relevant features from data originating from a monocular camera, one self-learning sub-model trained to extract relevant features from data originating from a LIDAR sensor, and so forth.

Furthermore, each first trained self-learning sub-model and the trained map generating self-learning model are preferably independent artificial neural networks.

Still further, according to another exemplary embodiment of the present disclosure, the step of online extracting, using the first trained self-learning model, the first plurality of features comprises projecting the received sensor data onto an image plane or a plane perpendicular to a direction of gravity in order to form at least one projected snapshot of the surrounding environment, and extracting, by means of the first trained self-learning model, the first plurality of features of the surrounding environment further based on the at least one projected snapshot. The image plane is to be understood as a plane containing a two-dimensional (2D) projection of the observed sensor data. For example, 3D point clouds perceived by LIDAR can be projected to a 2D image plane using intrinsic and extrinsic camera parameters. This information can subsequently be useful to determine or estimate a depth of an observed image by a camera. Alternatively, the image plane may be a plane (substantially) parallel to the direction of gravity, or a plane that a camera renders images.

Yet further, in accordance with yet another exemplary embodiment of the present disclosure, the method further comprises processing the received sensor data with the received geographical position in order to form a temporary perception of the surrounding environment, comparing the generated map with the temporary perception of the surrounding environment in order to form at least one parameter. Further, the method comprises comparing the first parameter with at least one predefined threshold, and sending a signal in order to update at least one weight of at least one of the first self-learning model and the map generating self-learning model based on the comparison between the at least one parameter and the at least one predefined threshold. In other words, the method may further include scalable and efficient process for evaluating and updating the map, or more specifically, for evaluating and updating the self-learning models used to generate the map in order to ensure that the map is as accurate and up-to-date as possible.

According to a second aspect of the present disclosure, there is provided a non-transitory computer-readable storage medium storing one or more programs configured to be executed by one or more processors of a vehicle control device, the one or more programs comprising instructions for performing a method for automated generation according to any one of the embodiments disclosed herein. With this aspect of the disclosure, similar advantages and preferred features are present as in the previously discussed first aspect of the disclosure.

Further, according to a third aspect of the present disclosure there is provided a vehicle control device for automated map making. The vehicle control device comprises a first module comprising a first trained self-learning model. The first module is configured to receive sensor data from a perception system of a vehicle. The perception system comprises at least one sensor type, and the sensor data comprises information about a surrounding environment of the vehicle. The first module is configured to online extract, using the first trained self-learning model, a first plurality of features of the surrounding environment based on the received sensor data. Further, the vehicle control device comprises a map generating module having a trained map generating self-learning model. The map generating module is configured to receive a geographical position of the vehicle from a localization system of the vehicle, and to online fuse, using the map generating self-learning model, the first plurality of features in order to form a second plurality of features. Further, the map generating module is configured to online generate, using the trained map generating self-learning model, a map of the surrounding environment in reference to a global coordinate system based on the second plurality of features and the received geographical position of the vehicle. With this aspect of the disclosure, similar advantages and preferred features are present as in the previously discussed first aspect of the disclosure.

According to a fourth aspect of the present disclosure, there is provided a vehicle comprising a perception system having at least one sensor type, a localization system, and a vehicle control device for automated map generation according to any one of the embodiments disclosed herein. With this aspect of the disclosure, similar advantages and preferred features are present as in the previously discussed first aspect of the disclosure.

Further, according to a fifth aspect of the present disclosure there is provided a method for automated map positioning of a vehicle on a map. The method comprises receiving sensor data from a perception system of a vehicle. The perception system comprises at least one sensor type, and the sensor data comprises information about a surrounding environment of the vehicle. The method further comprises online extracting, using a first trained self-learning model, a first plurality of features of the surrounding environment based on the received sensor data. Moreover, the method comprises receiving map data including a map representation of the surrounding environment of the vehicle, and online fusing, using a trained positioning self-learning model, the first plurality of features in order to form a second plurality of features. Next, the method comprises online determining, using the trained positioning self-learning model, a geographical position of the vehicle based on the received map data and the second plurality of features. Hereby presenting a method capable of precise and consistent positioning of a vehicle on the map by efficient utilization of trained self-learning models (e.g. artificial neural networks).

The automated positioning is based on similar principles as the automated map generation described in the foregoing, where two self-learning models are used, one “general” feature extraction part and one “task specific” feature fusion part. By separating the positioning method into two independent and co-operating components, advantages in scalability and flexibility are readily achievable. In more detail, complementary modules (such as e.g. the map generating model discussed in the foregoing) can be added to in order to form a complete map generating and map positioning solution. Thus, the received map data used for the map positioning may for example be map data outputted by the trained map generating self-learning model. Moreover, the same or similar advantages in terms of data storage, bandwidth, and workload are present as in the previously discussed first aspect of the disclosure.

A trained self-learning model may in the present context be understood as a trained artificial neural network, such as a trained convolutional or recurrent neural network.

Moreover, according to an exemplary embodiment of the present disclosure, the first trained self-learning model comprises an independent trained self-learning sub-model for each sensor type of the at least one sensor type. Each independent trained self-learning sub-model is trained to extract a predefined set of features from the received sensor data of an associated sensor type. In other words, the first trained self-learning model has one self-learning sub-model trained to extract relevant features from data originating from a RADAR sensor, one self-learning sub-model trained to extract relevant features from data originating from a monocular camera, one self-learning sub-model trained to extract relevant features from data originating from a LIDAR sensor, and so forth.

Furthermore, each first trained self-learning sub-model and the trained map positioning self-learning model are preferably independent artificial neural networks. This further elucidates the modularity and scalability of the proposed solution.

Still further, according to another exemplary embodiment of the present disclosure, the step of online extracting, using the first trained self-learning model, the first plurality of features comprises projecting the received sensor data onto an image plane or a plane perpendicular to a direction of gravity in order to form at least one projected snapshot of the surrounding environment, and extracting, by means of the first trained self-learning model, the first plurality of features of the surrounding environment further based on the at least one projected snapshot.

Yet further, in accordance with yet another exemplary embodiment of the present disclosure, the method further comprises receiving a set of reference geographical coordinates from a localization system of the vehicle, and comparing the determined geographical position with the received set of reference geographical coordinates in order to form at least one parameter. Further, the method comprises comparing the at least one parameter with at least one predefined threshold, and sending a signal in order to update at least one weight of at least one of the first self-learning model and the trained positioning self-learning model based on the comparison between the at least one parameter and the at least one predefined threshold. In other words, the method may further include scalable and efficient process for evaluating and updating the map positioning solution, or more specifically, for evaluating and updating the self-learning models used to position the vehicle in the map in order to ensure that the map positioning solution is as accurate and up-to-date as possible.

According to a sixth aspect of the present disclosure, there is provided a non-transitory computer-readable storage medium storing one or more programs configured to be executed by one or more processors of a vehicle control device, the one or more programs comprising instructions for performing a method for automated map positioning according to any one of the embodiments disclosed herein. With this aspect of the disclosure, similar advantages and preferred features are present as in the previously discussed fifth aspect of the disclosure.

Further, according to a seventh aspect of the present disclosure there is provided a vehicle control device for automated map positioning of a vehicle on a map. The vehicle control device comprises a first module comprising a first trained self-learning model. The first module is configured to receive sensor data from a perception system of a vehicle. The perception system comprises at least one sensor type, and the sensor data comprises information about a surrounding environment of the vehicle. The first module is further configured to online extract, using the first trained self-learning model, a first plurality of features of the surrounding environment based on the received sensor data. The vehicle control device further comprises a map-positioning module comprising a trained positioning self-learning model. The map-positioning module is configured to receive map data comprising a map representation of the surrounding environment of the vehicle, and to online fuse, using the trained positioning self-learning model, the selected subset of features in order to form a second plurality of features. Further the map-positioning module is configured to online determine, using the trained positioning self-learning model, a geographical position of the vehicle based on the received map data and the second plurality of features. With this aspect of the disclosure, similar advantages and preferred features are present as in the previously discussed fifth aspect of the disclosure.

Still further, according to an eighth aspect of the present disclosure there is provided a vehicle comprising a perception system comprising at least one sensor type, a localization system for determining a set of geographical coordinates of the vehicle, and a vehicle control device for automated map positioning according to any one of the embodiments disclosed herein. With this aspect of the disclosure, similar advantages and preferred features are present as in the previously discussed fifth aspect of the disclosure.

Further embodiments of the invention are defined in the dependent claims. It should be emphasized that the term “comprises/comprising” when used in this specification is taken to specify the presence of stated features, integers, steps, or components. It does not preclude the presence or addition of one or more other features, integers, steps, components, or groups thereof.

These and other features and advantages of the present invention will in the following be further clarified with reference to the embodiments described hereinafter.

### BRIEF DESCRIPTION OF THE DRAWINGS

Further objects, features and advantages of embodiments of the invention will appear from the following detailed description, reference being made to the accompanying drawings, in which:

FIG. 1 is a schematic flow chart representation of a method for automated map generation in accordance with an embodiment of the present disclosure.

FIG. 2 is a schematic side view illustration of a vehicle comprising a vehicle control device according to an embodiment of the present disclosure.

FIG. 3 is a schematic block diagram representation of a system for automated map generation in accordance with an embodiment of the present disclosure.

FIG. 4 is a schematic flow chart representation of a method for automated positioning of a vehicle on a map in accordance with an embodiment of the present disclosure.

FIG. 5 is a schematic side view illustration of a vehicle comprising a vehicle control device according to an embodiment of the present disclosure.

FIG. 6 is a schematic block diagram representation of a system for positioning of a vehicle on a map in accordance with an embodiment of the present disclosure.

FIG. 7 is a schematic block diagram representation of a system for automated map generation and positioning in accordance with an embodiment of the present disclosure.

### DETAILED DESCRIPTION

Those skilled in the art will appreciate that the steps, services and functions explained herein may be implemented using individual hardware circuitry, using software functioning in conjunction with a programmed microprocessor or general purpose computer, using one or more Application Specific Integrated Circuits (ASICs) and/or using one or more Digital Signal Processors (DSPs). It will also be appreciated that when the present disclosure is described in terms of a method, it may also be embodied in one or more processors and one or more memories coupled to the one or more processors, wherein the one or more memories store one or more programs that perform the steps, services and functions disclosed herein when executed by the one or more processors.

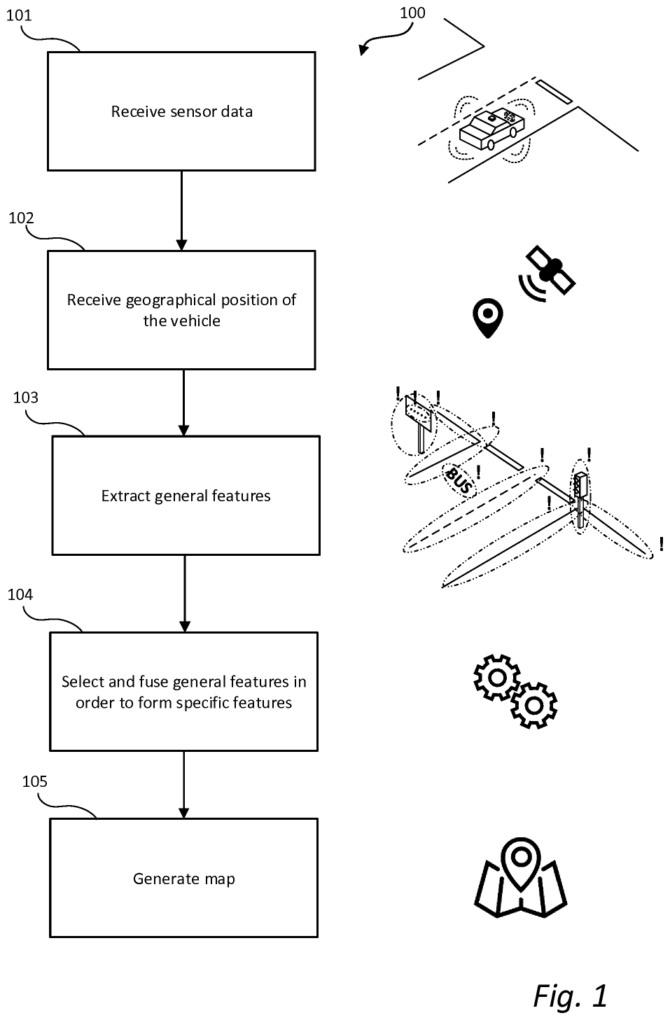

FIG. 1 illustrates a schematic flow chart representation of a method 100 for automated map generation in accordance with an embodiment of the present disclosure. The method 100 comprises receiving 101 sensor data from a perception system of a vehicle. The perception system comprises at least one sensor type (e.g. RADAR, LIDAR, monocular camera, stereoscopic camera, infrared camera, ultrasonic sensor, etc.), and the sensor data comprises information about a surrounding environment of the vehicle. In other words, a perception system is in the present context to be understood as a system responsible for acquiring raw sensor data from on-board sensors such as cameras, LIDARs and RADARs, ultrasonic sensors, and converting this raw data into scene understanding.

Further, the method 100 comprises receiving 102 a geographical position of the vehicle from a localization system of the vehicle. The localization system may for example be in the form of a global navigation satellite system (GNSS), such as e.g. GPS, GLONASS, BeiDou, and Galileo. Preferably, the localization system is a high precision positioning system such as e.g. a system combining GNSS with Real Time Kinematics technology (RTK), a system combining GNSS with inertial navigation systems (INS), GNSS using dual frequency receivers, and/or GNSS using augmentation systems. An augmentation system applicable for GNSS encompasses any system that aids GPS by providing accuracy, integrity, availability, or any other improvement to positioning, navigation, and timing that is not inherently part of GPS itself.

Further, the method 100 comprises online extracting 103, by means of a first trained self-learning model, a first plurality of features of the surrounding environment based on the received sensor data. In more detail, the step of extracting 103 a first plurality of features can be understood as a general feature extraction step, where a general feature extractor module/model is configured to identify various visual patterns in the perception data. The general feature extractor module has a trained artificial neural network such as e.g. a trained deep convolutional neural network or a trained recurrent neural network, or any other machine learning method. For example, the first plurality of features can be selected from the group comprising lines, curves, junctions, roundabouts, lane markings, road boundaries, surface textures, and landmarks. In other words, general features (first plurality of features) may be understood as “low-level” features that describe information about the geometry of the road or the topology of the road network.

Preferably, the received sensor data comprises information about the surrounding environment of the vehicle originating from a plurality of sensor types. Different sensor types contribute differently in perceiving the surrounding environment based on their properties. Thus, wherefore the output might result in different features being identified. For example, the collected features by RADARs can give accurate distance information but they might not provide sufficiently accurate angular information. Additionally, radars other general features may not be easily or accurately enough detect other general features, be detected by radars (such as for example vertical structures located above the street, lane markings or paints on the road.). However, cameras or LIDARs may be a better choice for detecting such features. Moreover, LIDARs can contribute in finding 3D road structures (curbs, barriers, etc.) that other sensor types could have a hard time to detect. By having several sensors of different types and properties, it may be be possible to extract more relevant general features describing the shape and the elements of the road where the vehicle is positioned.

In one exemplary embodiment of the present disclosure, the step of online extracting 103 the first plurality of features comprises projecting the received sensor data onto an image plane or a plane perpendicular to a direction of gravity (i.e. bird's eye view) in order to form at least one projected snapshot of the surrounding environment. Accordingly, the step of extracting 103 the first plurality of features is then based on the at least one projected snapshot. In other words, observations from the different sensor types (e.g. camera images, radar reflections, LIDAR point clouds, etc.) are firstly projected on the image plane or a plane perpendicular to the direction of gravity (i.e. a bird's eye view), and projected snapshots of the environment are created. These observations are then fed into the first trained self-learning model (i.e. artificial neural network) and the relevant features (i.e. visual patterns such lines, curves, junctions, roundabouts, etc.) are extracted 103. The image plane is to be understood as a plane containing a two-dimensional (2D) projection of the observed sensor data. For example, 3D point clouds perceived by LIDAR can be projected to a 2D image plane using intrinsic and extrinsic camera parameters. This information can subsequently be useful to determine or estimate a depth of an observed image by a camera. Alternatively, the image plane may be a plane (substantially) parallel to the direction of gravity or a plane that a camera renders images.

Moreover, in another exemplary embodiment of the present disclosure, the first trained self-learning model comprises an independent trained self-learning sub-model for each sensor type of the at least one sensor type. Moreover, each independent trained self-learning sub-model is trained to extract a predefined set of features from the received sensor data of an associated sensor type. This allows each sensor type's characteristics to be considered separately when training each sub-model whereby more accurate “general feature maps” can be extracted. In more detail, it was realized that different sensor types have different resolutions and different observation ranges which should be considered individually when designing/training the general feature extracting artificial neural network. In other words, there may be provided a trained self-learning sub-model for radar detections, one for LIDAR, one for monocular cameras, etc.

Further, the method 100 comprises online fusing 104, using a trained map generating self-learning model, the first plurality of features in order to form a second plurality of features. In more detail, the step of online fusing 104 the first plurality features can be understood as a “specific feature extraction”, where the general features extracted 103 by the first trained self-learning model, are used to generate “high-level” features. For example, the first plurality of features are used as input to the trained map generating self-learning model to generate lanes and the associated lane types (e.g. bus lane, emergency lane, etc.), as well as to determine and differentiate moving objects from stationary objects. The trained map generating self-learning model can also be realized as an artificial neural network such as e.g. a trained deep convolutional neural network, a trained recurrent neural network, or be based on any other machine learning method. Thus, the second plurality of features can be selected from the group comprising lanes, buildings, landmarks with semantic features, lane types, road edges, road surface types, and surrounding vehicles.

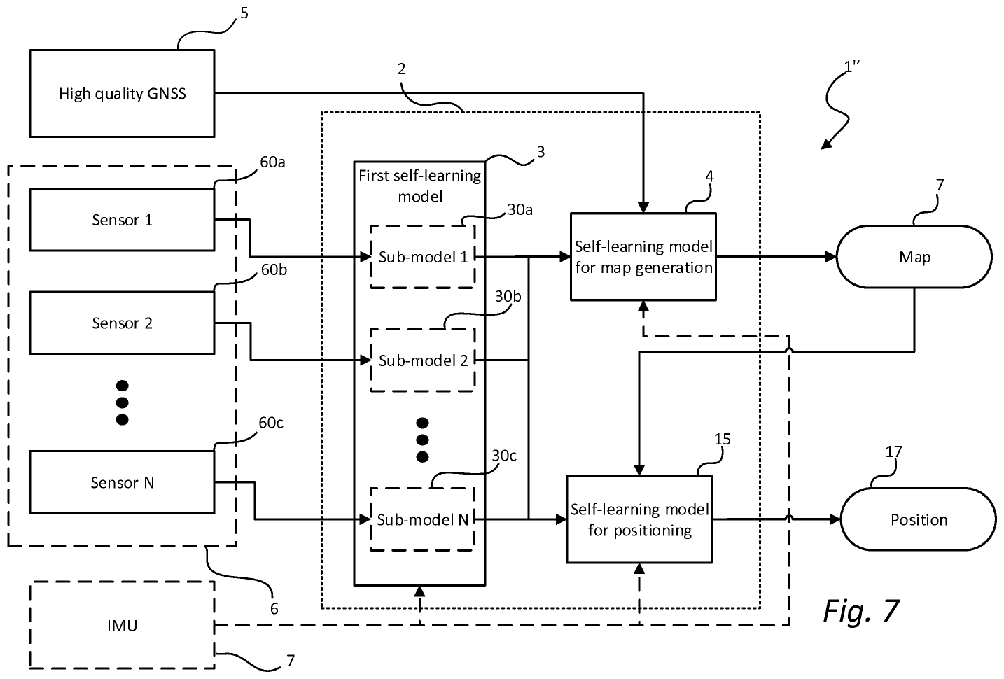

The feature fusion 104 may be preceded by a step of online selecting, using the trained map generating self-learning model, a subset of features from the plurality of features. This may be advantageous when the first trained self-learning model is trained to extract 103 more features than needed for the trained map generating self-learning model in order to generate 105 the map. Accordingly, the feature fusion 104 comprises online fusing, using the trained map generating self-learning module, the selected subset of features from the “general feature extraction 103”, provided by each of the sensors in order to generate map 105 with a higher accuracy and a better resolution. In more detail, as previously mentioned, the first trained self-learning model, can be construed as a module used for “general feature extraction” while the trained map generating self-learning model is more of a “task” specific module, i.e. a model trained to generate a map based on the extracted 103 first plurality of features. By using a more “general” feature extraction, additional modules within the same concept can be added, such as e.g. a positioning module (which will be exemplified with reference to FIG. 7), without having to add a completely new system.

Further, the method 100 comprises online generating 105, using the trained map generating self-learning model, a map of the surrounding environment in reference to a global coordinate system based on the second plurality of features and the received geographical position of the vehicle. Accordingly by means of the presented method 100, it is possible to realize a solution for efficient and automated map generation based on pure sensor data. An advantage of the proposed method is that the need for storing large quantities of data (high resolution maps) is alleviated since the only data that needs to be stored are the network weights (for the first and trained map generating self-learning models) if the data is to be processed locally. However, the proposed method may also be realized as a cloud-based solution where the sensor data is processed in remotely (i.e. in the “cloud”). Further, the step of online generating 105 the map may comprise determining, using the trained map generating self-learning model, a position of the second plurality of features in a global coordinate system based on the received geographical position of the vehicle.

For example, the first plurality of features may include one or more geometric features (e.g. lane, traffic sign, road sign, etc.) and at least one associated semantic feature (e.g. road markings, traffic sign markings, road sign markings, etc.). Accordingly, the step of online fusing 104 the first plurality of features may comprise combining, using the trained map generating self-learning model, the at least one geometric feature and the at least one associated semantic feature in order to provide at least a portion of the second plurality of features. The combination can be construed as a means for providing feature labels in the subsequently generated map.

The term “online” in reference to some of the steps of the method 100 is to be construed as that the step is done in real-time, i.e. as the data is received (sensor data, geographical position, etc.), the step is executed. Thus, the method 100 can be understood as that a solution where sensory data is collected, features are extracted and fused with e.g. GPS data, and a map of the surrounding environment is generated “on the go”. Stated differently, the method relies upon the concept of training an artificial intelligence (AI) engine to be able to recognize its surroundings and generate a high-resolution map automatically. The generated map can then serve as a basis upon which various other Autonomous Driving (AD) or Advanced Driver Assistance System (ADAS) features can operate.

Moreover, the method 100 may comprise a step receiving vehicle motion data from an inertial measurement unit (IMU) of the vehicle. Accordingly, the step of online extracting 103 the first plurality of features is further based on the received vehicle motion data. Thus, a vehicle motion model can be applied in the first processing step (general feature extraction) 103 in order to include e.g. the position information, velocity and the heading angle of vehicle. This could be used for different purposes such as improving the accuracy of the detected lane markings, road boundaries, landmarks, etc. using tracking methods, and/or for compensating for the pitch/yaw of the road.

Alternatively, the step of online fusing 104 the first plurality of features in order to form the second plurality of features, is based on the received vehicle motion data. Analogous advantages are applicable irrelevant of what processes step the vehicle motion data is accounted for as discussed above. However, a general advantage of the proposed method 100 is that processing of noisy data is embedded in the learning processes (while training the first and trained map generating self-learning models), thereby alleviating the need to resolve noise issues separately.

In other words, motion models, physical constraints, characteristics, and error models of each sensor (sensor type) are considered during a learning process (training of the self-learning models), whereby the accuracy of the generated map can be improved.

Moreover, the method 100 may further comprise (not shown) a step of processing the received sensor data with the received geographical position in order to form a temporary perception of the surrounding environment. Then the generated 105 map is compared with the temporary perception of the surrounding environment in order to form at least one parameter. In other words, a “temporary” map of the current perceived data from the on-board sensors is compared with the generated reference local map (i.e. the generated 105 map) given the “ground truth” position given by the high precision localization system of the vehicle. The comparison results in at least one parameter (e.g. a calculated error). Further, the method 100 may comprise comparing the first parameter with at least one predefined threshold, and sending a signal in order to update at least one weight of at least one of the first self-learning model and the map generating self-learning model based on the comparison between the at least one parameter and the at least one predefined threshold. In other words, the calculated error is evaluated with specific thresholds in order to determine if the probability of change (e.g. constructional changes) in the current local area is high enough. If the probability of change is high enough, it can be concluded that the “generated 105 map” may need to be updated. Thus, the size of the error can be calculated and propagated in the network (self-learning models) whereby weight changes can be communicated to the responsible entity (cloud or local).

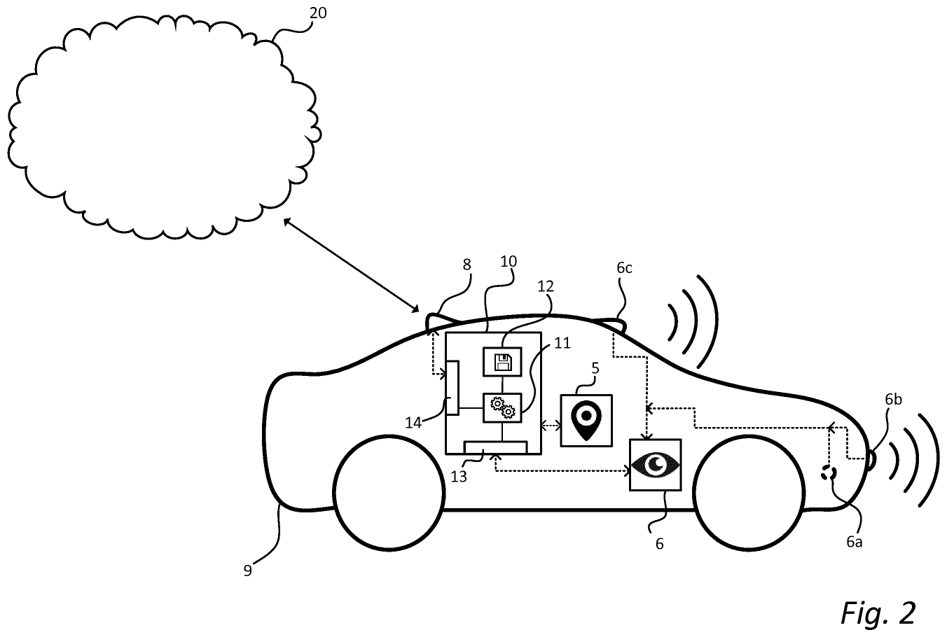

FIG. 2 is a schematic side view illustration of a vehicle 9 comprising a vehicle control device 10 according to an embodiment of the present disclosure. The vehicle 9 has a perception system 6 comprising a plurality of sensor types 60a-c (e.g. LIDAR sensor(s), RADAR sensor(s), camera(s), etc.). A perception system 6 is in the present context to be understood as a system responsible for acquiring raw sensor data from on-board sensors 60a-c such as cameras, LIDARs and RADARs, ultrasonic sensors, and converting this raw data into scene understanding. The vehicle further has a localization system 5, such as e.g. a high precision positioning system as described in the foregoing. Moreover, the vehicle 9 comprises a vehicle control device 10 having one or more processors (may also be referred to as a control circuit) 11, one or more memories 11, one or more sensor interfaces 13, and one or more communication interfaces.

The processor(s) 11 (associated with the control device 10) may be or include any number of hardware components for conducting data or signal processing or for executing computer code stored in memory 12. The device 10 has an associated memory 12, and the memory 12 may be one or more devices for storing data and/or computer code for completing or facilitating the various methods described in the present description. The memory may include volatile memory or non-volatile memory. The memory 12 may include database components, object code components, script components, or any other type of information structure for supporting the various activities of the present description. According to an exemplary embodiment, any distributed or local memory device may be utilized with the systems and methods of this description. According to an exemplary embodiment the memory 12 is communicably connected to the processor 11 (e.g., via a circuit or any other wired, wireless, or network connection) and includes computer code for executing one or more processes described herein. It should be appreciated that the sensor interface 13 may also provide the possibility to acquire sensor data directly or via dedicated sensor control circuitry 6 in the vehicle. The communication/antenna interface 14 may further provide the possibility to send output to a remote location 20 (e.g. remote operator or control centre) by means of the antenna 8. Moreover, some sensors 6a-c in the vehicle may communicate with the control device 10 using a local network setup, such as CAN bus, I2C, Ethernet, optical fibres, and so on. The communication interface 14 may be arranged to communicate with other control functions of the vehicle and may thus be seen as control interface also; however, a separate control interface (not shown) may be provided. Local communication within the vehicle may also be of a wireless type with protocols such as WiFi, LoRa, Zigbee, Bluetooth, or similar mid/short range technologies.

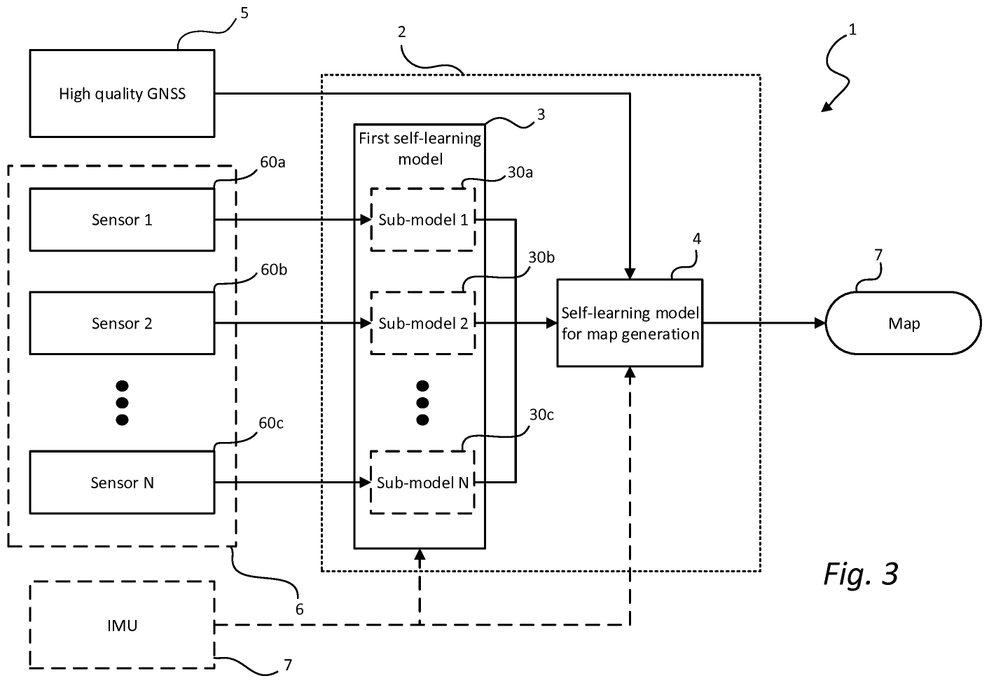

The working principles of the vehicle control device 10 will be further discussed in reference to FIG. 3, which illustrates a block diagram representing a system overview of an automated map generating solution according to an embodiment of the present disclosure. In more detail, the block diagram of FIG. 3 illustrates how the different entities of the vehicle control device communicate with other peripherals of the vehicle. The vehicle control device has a central entity 2 in the form of a learning engine 2, having a plurality of independent functions/modules 3, 4 with independent self-learning models. In more detail, the learning engine 2 has a first module 3 comprising a first trained self-learning model. As previously mentioned, the first trained self-learning model is preferably in the form of an artificial neural network that has been trained with several hidden layers along with other machine learning methods. For example, the first self-learning model can be a trained convolutional or recurrent neural network. Each module 3, 4 may be realized as a separate unit having its own hardware components (control circuitry, memory, etc.), or alternatively the learning engine unit may be realized as a single unit where the modules share common hardware components.

Further, the first module 3 is configured to receive sensor data from the perception system 6 of the vehicle. The perception system 6 comprises a plurality of sensor types 60a-c, and the sensor data comprises information about a surrounding environment of the vehicle. The first module 3 is further configured to online extract, using the first trained self-learning model, a first plurality of features of the surrounding environment based on the received sensor data. However, preferably the first trained self-learning model comprises an independent trained self-learning sub-model 30a-c for each sensor type 6a-c of the perception system 6. Thus, each independent trained self-learning sub-model 30a-c is trained to extract a predefined set of features from the received sensor data of an associated sensor type 6a-c.

The learning engine 2 of the vehicle control device further has a map generating module 4 comprising a trained map generating self-learning model. Analogously as with the first self-learning model, the trained map generating self-learning model may for example be a trained convolutional or recurrent neural network, or any other suitable artificial neural network.

Moving on, the mapmap generating module 4 is configured to receive a geographical position of the vehicle from the localization system 5 of the vehicle, and to online fuse, using the trained map generating self-learning model, the first plurality of features in order to form a second plurality of features. The first plurality of feature can be understood as general “low-level” features such as e.g. lines, curves, junctions, roundabouts, lane markings, road boundaries, surface textures, and landmarks. The second plurality of features are on the other hand “task specific” (in the present example case, the task is map generation) and may include features such as lanes, buildings, landmarks with semantic features, lane types, road edges, road surface types, and surrounding vehicles.

Further, the mapmap generating module 4 is configured to online generate, using the trained map generating self-learning model, a map of the surrounding environment in reference to a global coordinate system (e.g. GPS) based on the second plurality of features and the received geographical position of the vehicle. In more detail, the learning engine 2 enables the vehicle control device to generate high-resolution maps of the surrounding environment of any vehicle it is employed in “on the go” (i.e. online). In other words, the vehicle control device receives information about the surrounding environment from the perception system, and the self-learning models are trained to use this input to generate maps that can be utilized by other vehicle functions/features (e.g. collision avoidance systems, autonomous drive features, etc.).

The vehicle may further comprise an inertial measurement unit (IMU) 7, i.e. an electronic device that measures the vehicle body's specific force and angular rate using a combination of accelerometers and gyroscopes. The IMU output may advantageously be used to account for the vehicle's motion when performing the feature extraction or the feature fusion. Thus, the first module 3 may be configured to receive motion data from the IMU 7 and incorporate the motion data in the online extraction of the first plurality of features. This allows a vehicle motion model to be applied in the first processing step (general feature extraction) in order to include e.g. the position information, velocity and the heading angle of vehicle. This could be used for different purposes such as improving the accuracy of the detected lane markings, road boundaries, landmarks, etc. using tracking methods, and/or for compensating for the pitch/yaw of the road.

Alternatively, the map generating module 4 can be configured to receive motion data from the IMU 7, and to use the motion data in the feature fusion step. Similarly as discussed above, incorporating motion data allows for an improved accuracy in the feature fusion process since for example, measurement errors caused by vehicle movement can be accounted for.

Moreover, the system 1, and the vehicle control device (e.g. ref. 10 in FIG. 2) may further comprise a third module (may also be referred to as a map evaluation and update module). The third module (not shown) is configured to process the received sensor data with the received geographical position in order to form a temporary perception of the surrounding environment. Furthermore the third module is configured to compare the generated map with the temporary perception of the surrounding environment in order to form at least one parameter, and then compare the first parameter with at least one predefined threshold. Then, based on the comparison between the at least one parameter and the at least one predefined threshold, the third module is configured to send a signal in order to update at least one weight of at least one of the first self-learning model and the map generating self-learning model.

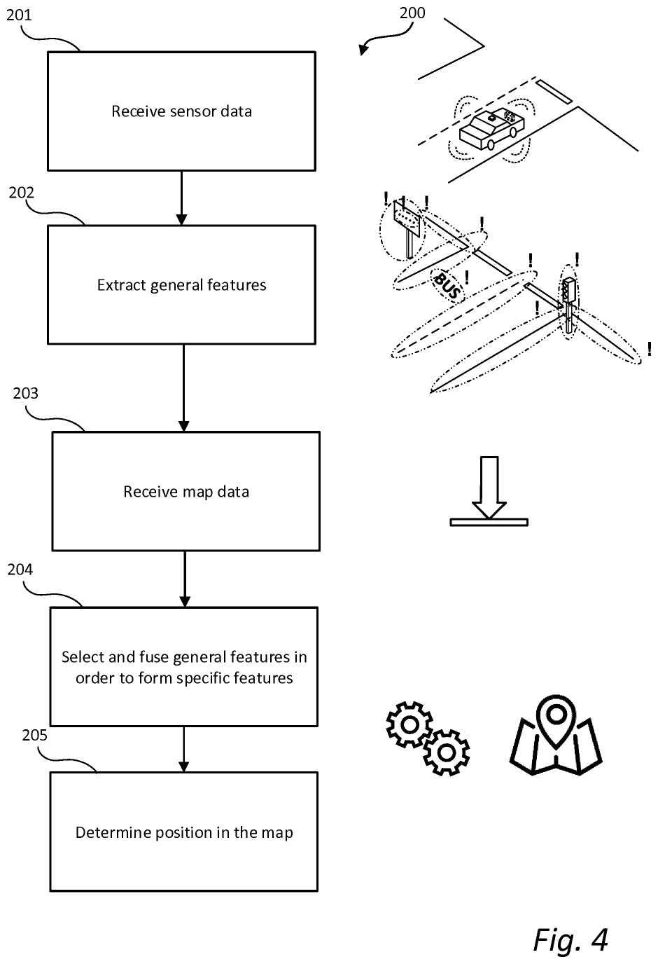

FIG. 4 is a schematic flow chart representation of a method 200 for automated positioning of a vehicle on a map in accordance with an embodiment of the present disclosure. The method 200 comprises receiving 201 sensor data from a perception system of a vehicle. The perception system comprises at least one sensor type (e.g. RADAR, LIDAR, monocular camera, stereoscopic camera, infrared camera, ultrasonic sensor, etc.), and the sensor data comprises information about a surrounding environment of the vehicle. In other words, a perception system is in the present context to be understood as a system responsible for acquiring raw sensor data from on sensors such as cameras, LIDARs and RADARs, ultrasonic sensors, and converting this raw data into scene understanding.

Further, the method 200 comprises online extracting 202, by means of a first trained self-learning model, a first plurality of features of the surrounding environment based on the received sensor data. In more detail, the step of extracting 202 a first plurality of features can be understood as a “general feature extraction” step, where a general feature extractor module is configured to identify various visual patterns in the perception data. The general feature extractor module has a trained artificial neural network such as e.g. a trained deep convolutional neural network or a trained recurrent neural network, or any other machine learning method. For example, the first plurality of features can be selected from the group comprising lines, curves, junctions, roundabouts, lane markings, road boundaries, surface textures, and landmarks.

In one exemplary embodiment of the present disclosure, the step of online extracting 202 the first plurality of features comprises projecting the received sensor data onto an image plane or a plane perpendicular to a direction of gravity (i.e. bird's-eye view) in order to form at least one projected snapshot of the surrounding environment. Accordingly, the step of extracting 202 the first plurality of features is then based on the at least one projected snapshot. In other words, observations from the different sensor types (e.g. camera images, radar reflections, LIDAR point clouds, etc.) are firstly projected on the image plane or a plane perpendicular to the direction of gravity (i.e. a bird's-eye view) and projected snapshots of the environment are created. These observations are then fed into the first trained self-learning model (i.e. artificial neural network) and the relevant features (i.e. visual patterns such lines, curves, junctions, roundabouts, etc.) are extracted 202.

Moreover, in another exemplary embodiment of the present disclosure, the first trained self-learning model comprises an independent trained self-learning sub-model for each sensor type of the at least one sensor type. Moreover, each independent trained self-learning sub-model is trained to extract a predefined set of features from the received sensor data of an associated sensor type. This allows each sensor type's characteristics to be considered separately when training each sub-model whereby more accurate “general feature maps” can be extracted. In more detail, it was realized that different sensor types have different resolutions and different observation ranges which should be considered individually when designing/training the general feature extracting artificial neural networks. In other words, there may be provided a trained self-learning sub-model for radar detections, one for LIDAR, one for monocular cameras, etc.

The method 200 further comprises receiving 203 map data comprising a map representation of the surrounding environment of the vehicle. The map data may be stored locally in the vehicle or remotely in a remote data repository (e.g. in the “cloud”). However, the map data may be in the form of the automatically generated map as discussed in the foregoing with reference to FIGS. 1-3. Thus, the map data may be generated “online” in the vehicle while the vehicle is traveling. However, the map data may also be received 203 from a remote data repository comprising an algorithm that generates the map “online” based on sensor data transmitted by the vehicle to the remote data repository. Thus, the concepts of the automated map generation and positioning in the map may be combined (will be further discussed in reference to FIGS. 7-8).

Further, the method 200 comprises online fusing 204, using a trained map positioning self-learning model, the first plurality of features in order to form a second plurality of features. In more detail, the step of online fusing 204 the first plurality features can be understood as a “specific feature extraction”, where the general features extracted 103 by the first trained self-learning model, are used to generate “high-level” features. For example, the first plurality of features are used as input to the trained map positioning self-learning model to identify lanes and the associated lane types (e.g. bus lane, emergency lane, etc.), as well as to determine and differentiate moving objects from stationary objects. The trained map positioning self-learning model can also be realized as an artificial neural network such as e.g. a trained deep convolutional neural network or a trained recurrent neural network, or be based on any other machine learning method. Thus, the second plurality of features can be selected from the group comprising lanes, buildings, landmarks with semantic features, lane types, road edges, road surface types, and surrounding vehicles.

The feature fusion 204 may be preceded by a step of online selecting, using the trained map positioning self-learning model, a subset of features from the plurality of features. This may be advantageous when the first trained self-learning model is trained to extract 202 more features than needed for the trained map positioning self-learning model in order to determine 205 a position on the map. Moreover, the feature fusion 204 comprises online fusing, using the trained map positioning self-learning module, the selected subset of features from “general feature extraction 202”, provided by each of the sensors in order to determine 205 the position with a higher accuracy. In more detail, as previously mentioned, the first trained self-learning model, can be construed as a module used for “general feature extraction” while the trained map positioning self-learning model is more of a “task” specific model, i.e. a model trained to position the vehicle in the map. By using a more “general” feature extraction, additional modules within the same concept can be added, such as e.g. a map generating module (which will be exemplified with reference to FIG. 7), without having to add a completely new system.

The term “online” in reference to some of the steps of the method 200 is to be construed as that the step is done in real-time, i.e. as the data is received (sensor data, geographical position, etc.), the step is executed. Thus, the method 200 can be understood as that a solution where sensory data is collected, some features are extracted and fused together, map data is received and a position in the map is determined “on the go”. Stated differently, the method relies upon the concept of training an artificial intelligence (AI) engine to be able to recognize its surroundings and determine a position in a map automatically. The determined position can then serve as a basis upon which various other Autonomous Driving (AD) or Advanced Driver Assistance System (ADAS) features can function.

Moreover, the method 200 may comprise a step receiving vehicle motion data from an inertial measurement unit (IMU) of the vehicle. Accordingly, the step of online extracting 202 the first plurality of features is further based on the received vehicle motion data. Thus, a vehicle motion model can be applied in the first processing step (general feature extraction) 202 in order to include e.g. the position information, velocity and the heading angle of vehicle. This could be used for different purposes such as improving the accuracy of the detected lane markings, road boundaries, landmarks, etc. using tracking methods, and/or for compensating for the pitch/yaw of the road.

Alternatively, the step of online fusing 204 the first plurality of features in order to form the second plurality of features, is based on the received vehicle motion data. Analogous advantages are applicable irrelevant of what processes step the vehicle motion data is accounted for as discussed above. However, a general advantage of the proposed method 200 is that processing of noisy data is embedded in the learning processes (while training the first and trained map generating self-learning models), thereby alleviating the need to resolve noise issues separately.

In other words, motion models, physical constraints, characteristics, and error models of each sensor (sensor type) are considered during a learning process (training of the self-learning models), whereby the accuracy of the determined position can be improved.

The method 200 may further comprise an evaluation and updating process in order to determine the quality of the self-learning models for positioning purposes. Accordingly, the method 200 may comprise receiving a set of reference geographical coordinates from a localization system of the vehicle, and comparing the determined 205 geographical position with the received set of reference geographical coordinates in order to form at least one parameter. Further, the method 200 may comprise comparing the at least one parameter with at least one predefined threshold, and based on this comparison, sending a signal in order to update at least one weight of at least one of the first self-learning model and the trained positioning self-learning model.

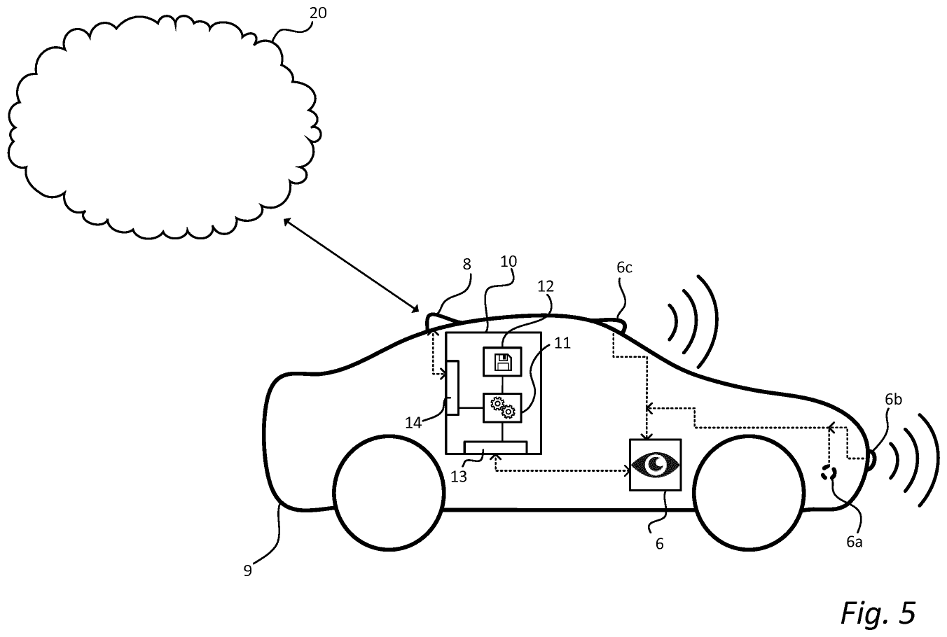

FIG. 5 is a schematic side view illustration of a vehicle 9 comprising a vehicle control device 10 according to an embodiment of the present disclosure. The vehicle 9 has a perception system 6 comprising a plurality of sensor types 60a-c (e.g. LIDAR sensor(s), RADAR sensor(s), camera(s), etc.). A perception system 6 is in the present context to be understood as a system responsible for acquiring raw sensor data from on sensors 60a-c such as cameras, LIDARs and RADARs, ultrasonic sensors, and converting this raw data into scene understanding. The vehicle further has a localization system 5, such as e.g. a high precision positioning system as described in the foregoing. Moreover, the vehicle 9 comprises a vehicle control device 10 having one or more processors (may also be referred to as a control circuit) 11, one or more memories 11, one or more sensor interfaces 13, and one or more communication interfaces.

The processor(s) 11 (associated with the control device 10) may be or include any number of hardware components for conducting data or signal processing or for executing computer code stored in memory 12. The device 10 has an associated memory 12, and the memory 12 may be one or more devices for storing data and/or computer code for completing or facilitating the various methods described in the present description. The memory may include volatile memory or non-volatile memory. The memory 12 may include database components, object code components, script components, or any other type of information structure for supporting the various activities of the present description. According to an exemplary embodiment, any distributed or local memory device may be utilized with the systems and methods of this description. According to an exemplary embodiment the memory 12 is communicably connected to the processor 11 (e.g., via a circuit or any other wired, wireless, or network connection) and includes computer code for executing one or more processes described herein.

It should be appreciated that the sensor interface 13 may also provide the possibility to acquire sensor data directly or via dedicated sensor control circuitry 6 in the vehicle. The communication/antenna interface 14 may further provide the possibility to send output to a remote location 20 (e.g. remote operator or control centre) by means of the antenna 8. Moreover, some sensors 6a-c in the vehicle may communicate with the control device 10 using a local network setup, such as CAN bus, I2C, Ethernet, optical fibres, and so on. The communication interface 14 may be arranged to communicate with other control functions of the vehicle and may thus be seen as control interface also; however, a separate control interface (not shown) may be provided. Local communication within the vehicle may also be of a wireless type with protocols such as WiFi, LoRa, Zigbee, Bluetooth, or similar mid/short range technologies.

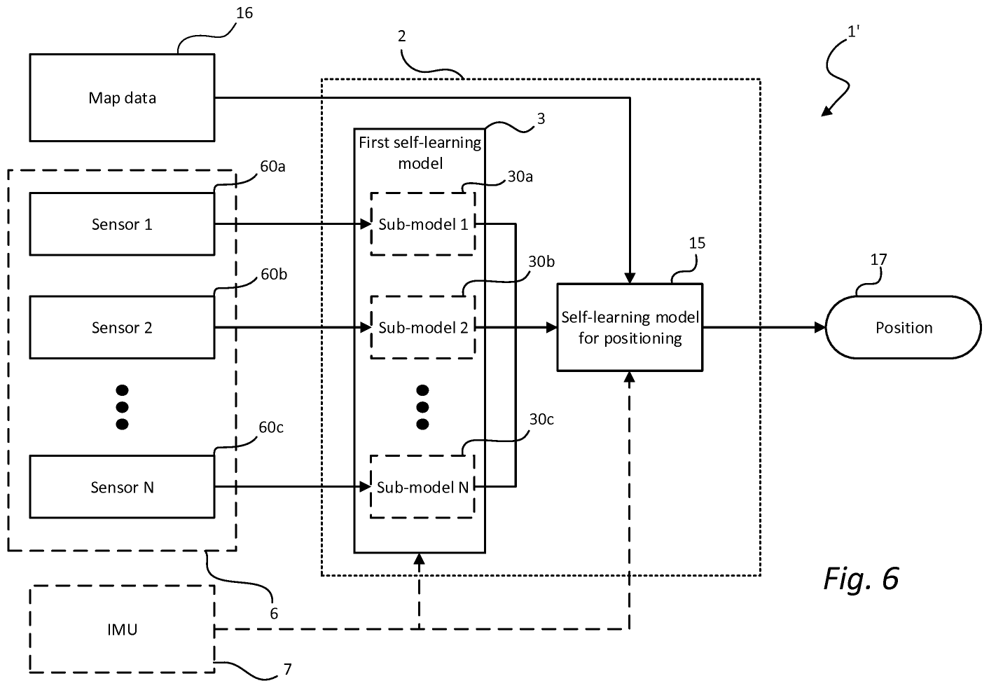

The working principles of the vehicle control device 10 will be further elaborated upon in reference to FIG. 6, which illustrates a schematic block diagram representing a system 1′ overview of an automated map-positioning solution according to an embodiment of the present disclosure. In more detail, the block diagram of FIG. 6 illustrates how the different entities of the vehicle control device communicate with other peripherals of the vehicle. The vehicle control device has a central entity 2 in the form of a learning engine 2, having a plurality of independent functions/modules 3, 15 with independent self-learning models. In more detail, the learning engine 2 has a first module 3 comprising a first trained self-learning model. As previously mentioned, the first trained self-learning model is preferably in the form of an artificial neural network that has been trained with several hidden layers along with other machine learning methods. For example, the first self-learning model can be a trained convolutional or recurrent neural network. Each module 3, 15 may be realized as a separate unit having its own hardware components (control circuitry, memory, etc.), or alternatively the learning engine unit may be realized as a single unit where the modules share common hardware components.

Further, the first module 3 is configured to receive sensor data from the perception system 6 of the vehicle. The perception system 6 comprises a plurality of sensor types 60a-c, and the sensor data comprises information about a surrounding environment of the vehicle. The first module 3 is further configured to online extract, using the first trained self-learning model, a first plurality of features of the surrounding environment based on the received sensor data. However, preferably the first trained self-learning model comprises an independent trained self-learning sub-model 30a-c for each sensor type 6a-c of the perception system 6. Thus, each independent trained self-learning sub-model 30a-c is trained to extract a predefined set of features from the received sensor data of an associated sensor type 6a-c.

The learning engine 2 of the vehicle control device further has a map-positioning module 15 comprising trained map positioning self-learning model. Analogously as with the first self-learning model, the trained map positioning self-learning model may for example be a trained convolutional or recurrent neural network, or any other suitable artificial neural network.

Moving on, the map-positioning module 15 is configured to receive map data comprising a map representation of the surrounding environment of the vehicle (in a global coordinate system), and to online fuse, using the trained positioning self-learning model, the first plurality of features in order to form a second plurality of features. The first plurality of feature can be understood as general “low-level” features such as e.g. lines, curves, junctions, roundabouts, lane markings, road boundaries, surface textures, and landmarks. The second plurality of features are on the other hand “task specific” (in the present example case, the task is map-positioning) and may include features such as lanes, buildings, static objects, and road edges.

Further, the map-positioning module 15 is configured to online generate, using the trained map-positioning self-learning model, a geographical position of the vehicle based on the received map data and the second plurality of features. In more detail, the learning engine 2 enables the vehicle control device to precisely determine a position of the vehicle in the surrounding environment of any vehicle it is employed in, in a global coordinate system, “on the go” (i.e. online). In other words, the vehicle control device receives information about the surrounding environment from the perception system, and the self-learning models are trained to use this input to determine a geographical position of the vehicle in a map, which position can be utilized by other vehicle functions/features (e.g. lane tracking systems, autonomous drive features, etc.).

The vehicle may further comprise an inertial measurement unit (IMU) 7, i.e. an electronic device that measures the vehicle body's specific force and angular rate using a combination of accelerometers and gyroscopes. The IMU output may advantageously be used to account for the vehicle's motion when performing the feature extraction or the feature fusion. Thus, the first module 3 may be configured to receive motion data from the IMU 7 and incorporate the motion data in the online extraction of the first plurality of features. This allows a vehicle motion model to be applied in the first processing step (general feature extraction) in order to include e.g. the position information, velocity and the heading angle of vehicle. This could be used for different purposes such as improving the accuracy of the detected lane markings, road boundaries, landmarks, etc. using tracking methods, and/or for compensating for the pitch/yaw of the road.

Alternatively, the map positioning module 15 can be configured to receive motion data from the IMU 7, and to use the motion data in the feature fusion step. Similarly as discussed above, incorporating motion data allows for an improved accuracy in the feature fusion process since for example, measurement errors caused by vehicle movement can be accounted for.

FIG. 7 illustrates a schematic block diagram representing a system overview of an automated map-generating and map-positioning solution according to an embodiment of the present disclosure. The independent aspects and features of the map-generating system and the map-positioning system have already been discussed in detail in the foregoing and will for the sake of brevity and conciseness not be further elaborated upon. The block diagram of FIG. 7 illustrates how the learning engine 2 of a vehicle control device can be realized in order to provide an efficient and robust means for automatically creating an accurate map of the vehicle surroundings and positioning the vehicle in the created map. More specifically, the proposed system 1″ can provide advantages in terms of time efficiency, scalability, and data storage.

Moreover, a common “general feature extraction module” i.e. the first module 3 is used by both of the task-specific self-learning models 4, 15, thereby providing an integrated map-generating and map-positioning solution. In more detail, the task-specific modules/models 4, 15 are configured to fuse the extracted features at the earlier stage 3 to find more high-level or semantic features that can be important for the desired task (i.e. map generation or positioning). Specific features might be different regarding the desired task. For example, some features could be necessary for map generation but not useful or necessary for positioning, for example the value of the detected speed limit sign or the type of the lane (bus, emergency, etc.) can be considered to be important for map generation but less important for positioning. However, some specific features could be common between different tasks such as lane markings since they can be considered to be important for both map-generation and the map-positioning.

The present inventors realized that map generation and position based on projected snapshots of data is suitable since self-learning models (e.g. artificial neural networks) can be trained to detect elements in images (i.e. feature extraction). Moreover, everything that has a geometry looks like an image, there are readily available tools and methods for image processing dealing well with sensor imperfection, and images can be compressed without losing information. Thus, by utilizing a combination of general feature extraction and task-specific feature fusion, it is possible to realize a solution for map generation and positioning which is modular, hardware and sensor type agnostic, robust in terms of noise handling, without consuming significant amounts of memory. In reference to the data storage requirements, the proposed solutions can in practice only store the network weights (of the self-learning models) and continuously generate maps and positions without storing any map or positional data.

Accordingly, it should be understood that parts of the described solution may be implemented either in the vehicle, in a system located external the vehicle, or in a combination of internal and external the vehicle; for instance in a server in communication with the vehicle, a so called cloud solution. For instance, sensor data may be sent to an external system and that system performs all or parts of the steps to determine the action, predict an environmental state, comparing the predicted environmental state with the received sensor data, and so forth. The different features and steps of the embodiments may be combined in other combinations than those described.

It should be noted that the word “comprising” does not exclude the presence of other elements or steps than those listed and the words “a” or “an” preceding an element do not exclude the presence of a plurality of such elements. It should further be noted that any reference signs do not limit the scope of the claims, that the invention may be at least in part implemented by means of both hardware and software, and that several “means” or “units” may be represented by the same item of hardware.

Although the figures may show a specific order of method steps, the order of the steps may differ from what is depicted. In addition, two or more steps may be performed concurrently or with partial concurrence. For example, the steps of receiving signals comprising information about a movement and information about a current road scenario may be interchanged based on a specific realization. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps. The above mentioned and described embodiments are only given as examples and should not be limiting to the present invention. Other solutions, uses, objectives, and functions within the scope of the invention as claimed in the below described patent embodiments should be apparent for the person skilled in the art.

1. A method for automated map generation, the method comprising:
receiving sensor data from a perception system of a vehicle, the perception system comprising at least one sensor type, and the sensor data comprising information about a surrounding environment of the vehicle;
receiving a geographical position of the vehicle from a localization system of the vehicle;
online extracting, using a first trained self-learning model, a first plurality of features of the surrounding environment based on the received sensor data,
online fusing, using a trained map generating self-learning model, the first plurality of features in order to form a second plurality of features; and
online generating, using the trained map generating self-learning model, a map of the surrounding environment, in reference to a global coordinate system based on the second plurality of features and the received geographical position of the vehicle.

2. The method according to claim 1, wherein the first trained self-learning model comprises an independent trained self-learning sub-model for each sensor type of the at least one sensor type; and
wherein each independent trained self-learning sub-model is trained to extract a predefined set of features from the received sensor data of an associated sensor type.

3. The method according to claim 2, wherein each independent trained self-learning sub-model and the trained map generating self-learning model are independent artificial neural networks.

4. The method according to claim 1, further comprising:
receiving vehicle motion data from an inertial measurement unit, IMU, of the vehicle,
wherein the step of online extracting, using the first trained self-learning model, the first plurality of features is further based on the received vehicle motion data.

5. The method according to claim 1, further comprising:
receiving vehicle motion data from an inertial measurement unit, of the vehicle,
wherein the step of online fusing, using the trained map generating self-learning model, the first plurality of features is based on the received vehicle motion data.

6. The method according to claim 1, further comprising:
online selecting, using the trained map generating self-learning model, a subset of features from the plurality of features; and
wherein the step of online fusing, using the trained map generating self-learning model, the first plurality of features comprises online fusing, using the trained map generating self-learning model, the selected subset of features in order to form the second plurality of features.

7. The method according to claim 1, wherein the step of online extracting, using the first trained self-learning model, the first plurality of features comprises:
projecting the received sensor data onto an image plane or a plane perpendicular to a direction of gravity in order to form at least one projected snapshot of the surrounding environment; and
extracting, by means of the first trained self-learning model, the first plurality of features of the surrounding environment based on the at least one projected snapshot.

8. The method according to claim 1, wherein the first plurality of features is selected from the group comprising lines, curves, junctions, roundabouts, lane markings, road boundaries, surface textures, and landmarks.

9. The method according to claim 1, wherein the second plurality of features is selected from the group comprising lanes, buildings, landmarks with semantic features, lane types, road edges, road surface types, and surrounding vehicles.

10. The method according to claim 1, wherein the first plurality of features comprises at least one geometric feature and at least one associated semantic feature;
wherein the step of online fusing, using the trained map generating self-learning model, the first plurality of features comprises combining, using the trained map generating self-learning model, the at least one geometric feature and the at least one associated semantic feature in order to provide at least a portion of the second plurality of features; and
wherein the step of generating the map of the surrounding environment comprises determining, using the trained map generating self-learning model, a position of the second plurality of features in a global coordinate system based on the received geographical position of the vehicle.

11. The method according to claim 1, wherein the plurality of features comprises static and dynamic objects, and wherein the step of online generating, using the trained map generating self-learning model, the map comprises:
identifying and differentiating the static and dynamic objects.

12. The method according to claim 1, further comprising:
processing the received sensor data with the received geographical position in order to form a temporary perception of the surrounding environment;
comparing the generated map with the temporary perception of the surrounding environment in order to form at least one parameter;
comparing the first parameter with at least one predefined threshold;
sending a signal in order to update at least one weight of at least one of the first trained self-learning model and the trained map generating self-learning model based on the comparison between the at least one parameter and the at least one predefined threshold.

13. A non-transitory computer-readable storage medium storing one or more programs configured to be executed by one or more processors of a vehicle control device, the one or more programs comprising instructions for performing the method according to claim 12.

14. A vehicle control device for automated map making, the vehicle control device comprising:
a first module comprising a first trained self-learning model, the first nodule being configured to:
receive sensor data from a perception system of a vehicle, the perception system comprising at least one sensor type, and the sensor data comprising information about a surrounding environment of the vehicle;
online extract, using the first trained self-learning model, a first plurality of features of the surrounding environment based on the received sensor data;
a map generating module comprising a trained map generating self-learning model, the map generating module being configured to:
receive a geographical position of the vehicle from a localization system of the vehicle;
online fuse, using the trained map generating self-learning model, the first plurality of features in order to form a second plurality of features: and
online generate, using the trained map generating self-learning model, a map of the surrounding environment in reference to a global coordinate system based on the second plurality of features and the received geographical position of the vehicle.

15. The vehicle control device according to claim 14, wherein the first trained self-learning model comprises an independent trained self-learning sub-model for each sensor type of the at least one sensor type; and
wherein each independent trained self-learning sub-model is trained to extract a predefined set of features from the received sensor data of an associated sensor type.

16. The vehicle control device according to claim 14, wherein the first module is further configured to:
receive motion data from an inertial measurement unit, IMU, of the vehicle; and
online extract, using the first trained self-learning model, the first plurality of features is further based on the received motion data.

17. The vehicle control device according to claim 14, wherein the map generating module is further configured to:
receive motion data from an inertial measurement unit, IMU, of the vehicle; and
online fuse, using the trained map generating self-learning model, the first plurality of features is based on the received motion data.

18. The vehicle control device according to claim 14, wherein the map generating module is further configured to:
online select, using the trained map generating self-learning model, a subset of features from the first plurality of features; and
online fuse, using the trained map generating self-learning model, the first plurality of features by online fusing, using the trained map generating self-learning model, the selected subset of features in order to form the second plurality of features.

19. The vehicle control device according to claim 14, further comprising a third module configured to:
process the received sensor data with the received geographical position in order to form a temporary perception of the surrounding environment;
compare the generated map with the temporary perception of the surrounding environment in order to form at least one parameter;
compare the first parameter with at least one predefined threshold;
send a signal in order to update at least one weight of at least one of the first trained self-learning model and the trained map generating self-learning model based on the comparison between the at least one parameter and the at least one predefined threshold.

20. A vehicle comprising:
a perception system comprising at least one sensor type;
a localization system for determining a geographical position of the vehicle;
a vehicle control device for automated map making, the vehicle control device comprising:
a first module comprising a first trained self-learning model, the first module being configured to:
receive sensor data from a perception system of a vehicle, the perception system comprising at least one sensor type, and the sensor data comprising information about a surrounding environment of the vehicle;
online extract, using the first trained self-learning model, a first plurality of features of the surrounding environment based on the received sensor data;
a map generating module comprising a trained map generating self-learning model the map generating module being configured to:
receive a geographical position of the vehicle from a localization system of the vehicle;
online fuse, using the trained map generating self-learning model, the first plurality of features in order to form a second plurality of features; and
online generate, using the trained map generating self-learning model, a map of the surrounding environment in reference to a global coordinate system based on the second plurality of features and the received geographical position of the vehicle.

21-42. (canceled)
